(19) United States
(12) Patent Application Publication
(10) Pub. No.: US 2025/0190841 A1
(43) Pub. Date: Jun. 12, 2025

(54) ORDERING NODES FOR TENSOR NETWORK CONTRACTION BASED QUANTUM COMPUTING SIMULATION

(71) Applicants: UNIVERSITY OF DELAWARE, Newark, DE (US); Argonne National Laboratory, Lemont, IL (US)

(72) Inventors: Ilya SAFRO, Newark, DE (US); Cameron IBRAHIM, Newark, DE (US); Yuri ALEXEEV, Lemont, IL (US); Danil LYKOV, Lemont, IL (US)

(73) Assignees: UNIVERSITY OF DELAWARE, Newark, DE (US); Argonne National Laboratory, Lemont, IL (US)

(21) Appl. No.: 19/055,021

(22) Filed: Feb. 17, 2025

Related U.S. Application Data
(63) Continuation of application No. PCT/US2023/030464, filed on Aug. 17, 2023.
(60) Provisional application No. 63/398,758, filed on Aug. 17, 2022.

(51) Int. Cl. G06N 10/80

(52) U.S. Cl. CPC G06N 10/80

(57) ABSTRACT

A classical computer includes a classical processor and a classical memory coupled to the classical processor. The classical memory includes a gate-graph conversion array, which itself includes at least one correspondence between a conversion quantum gate and a conversion graphical representation. The classical memory further includes classical programming in the classical memory. Execution of the classical programming configures the classical computer to perform the following functions. Receive a plurality of quantum circuit input files, where each quantum circuit input file includes a quantum circuit comprising an input quantum gate. Convert each quantum circuit into a tensor graph by utilizing the gate-graph conversion array. Evaluate the tensor graph as a contraction tree. Output a selected quantum circuit input file of the plurality of quantum circuit input files, with a potential to demonstrate quantum advantage over one or more non-selected quantum circuit input files of the plurality of quantum circuit input files.

### CROSS REFERENCE TO RELATED APPLICATIONS

This invention claims the benefit of priority of U.S. provisional application No. 63/398,758, filed on Aug. 17, 2022, the entire contents of which is incorporated by reference herein for all purposes.

### FIELD OF INVENTION

The invention relates to simulators of tensor network quantum circuits, and constructing optimal contraction trees to improve the simulation of tensor network quantum circuits.

### BACKGROUND

Tensor networks have become a ubiquitous tool for describing high dimensional, data-sparse tensors in a space efficient manner. In quantum circuit simulation, tensor networks can be used to model circuits with far more quantum bits (qubits) than a more direct approach such as state vector simulation, so long as the circuit is sufficiently simple. As such, tensor network-based simulation methods are vital for the study of quantum algorithms that require a large number of qubits. Moreover, even with hypothetical advanced quantum hardware to execute quantum algorithms, tensor network-based simulation methods executed by classical computing hardware will be important for tasks such as finding suitable parameters in variational quantum algorithms that utilize both quantum and classical machines. These tensor networks arise naturally in a variety of disciplines such as Probabilistic Modelling, Constraint Satisfaction, Machine Learning and Data Mining, Physics Modelling, and Quantum & Classical Circuit Simulation.

A tensor network is most easily conceptualized as a collection of high-order matrices called tensors which are connected by edges. These tensor networks often represent tensors which are impractical to store explicitly in the memory of a classical computer. The fundamental operation performed on these tensor networks is called a tensor contraction, where two tensors are combined to create a third tensor. A series of tensor contractions performed on the tensor network is called a tensor network contraction, which is used to reduce the overall size of the tensor network in order to evaluate entries of the underlying tensor that the network represents.

In contracting a tensor network, it is useful to represent a tensor network contraction as a contraction tree, a binary tree whose leaves are tensors in the network, where each internal vertex represents the tensor contraction of its two children. In the general case, the cost of any single tensor contraction is exponential in the number of dimensions of its inputs, as is the size of its output. As such, a vital part of performing a tensor network contraction is choosing a contraction tree which minimizes some cost, such as minimizing the size of any intermediary tensor or the total number of operations performed during your tensor network contraction. However, it is NP-hard to construct an optimal contraction tree in the general case for these objectives, meaning no optimal solution has been found deterministically in polynomial time.

Finding combinatorial optimization problems and their instances that run efficiently and faster on quantum devices rather than on classical computers is of great importance in the fields of mathematics, computing, and cryptography. The ability to determine whether a series of quantum circuits can be configured to solve combinatorial optimization problems can allow for efficient solving of real-world logistical problems which currently rely on rough heuristics. Problems that run efficiently and faster on quantum devices may include cryptographic and security problems: efficient solving may allow to decryption of data presumed to be unreadable, and may allow for more secure encryption methods.

Prior art methods of qubit circuit assembly are extremely time and resource consuming: assembling a circuit of even ten qubits requires a space kept at near absolute zero, and precise smelting and machining in order to induce proper functionality: a far cry from the massive number of classic transistors currently found in a classical processing unit. The methods of identifying strong quantum circuit diagrams, likely to present a quantum advantage over a classical processing unit, may substantially and materially reduce the time and material cost of the prototyping phase of a quantum processing unit, or a quantum circuit with quantum superiority at solving certain problems and their instances over a classical circuit.

### SUMMARY OF THE INVENTION

Hence, there is room for further improvement in the construction of optimal tensor contraction trees. The computationally hard portion of constructing a contraction tree can be reduced to a problem of linear ordering, and certain devised algorithms can construct an optimal contraction tree for a given ordering. Useful heuristics can be applied in choosing orderings, resulting in high quality contraction trees. High quality contraction trees, and therefore good quality contraction orders, are needed to run simulations of quantum circuits with large numbers of qubits. Finding optimal or near optimal contraction orders is critical for the development and testing of new quantum algorithms, verification of quantum advantage and supremacy claims, and in particular benchmarking and profiling upcoming quantum devices. Incremental improvements to the quality of a contraction tree may lead to a significant acceleration of quantum simulation. The contraction tree solving systems and methods described herein demonstrate an improvement over existing contraction tree solvers by orders of magnitude for comparable running times.

In accordance with an aspect of the present invention, a classical computer includes a classical processor and a classical memory coupled to the classical processor. As used herein, the term “classical” when used to modify terms such as “computer,” “processor,” “memory,” and the like, refers to a computer system and its components that use traditional techniques long known in the art, as compared to “quantum” computing techniques as referred to elsewhere herein. The classical computer includes a gate-graph conversion array in the classical memory, which itself includes at least one correspondence between a conversion quantum gate and a conversion graphical representation. The classical memory further includes classical programming in the classical memory, wherein execution of the classical programming by the classical processor configures the classical computer to perform the following functions: receiving a plurality of quantum circuit input files where each quantum circuit input file includes a quantum circuit comprising at least one input quantum gate; converting each quantum circuit into a tensor graph by utilizing the gate-graph conversion array; evaluating the tensor graph as a contraction tree; and outputting a selected quantum circuit input file of the plurality of quantum circuit input files, with a potential to demonstrate quantum advantage over one or more non-selected quantum circuit input files of the plurality of quantum circuit input files.

The classical computer can include a quantum processing unit fabricator, configured to fabricate one or more quantum processing units conforming to the selected quantum circuit input file. Execution of the classical programming by the classical processor configures the classical computer to perform the function of fabricating, via the quantum processing unit fabricator, a quantum processing unit conforming to the selected quantum circuit input file.

The tensor graph can include at least two tensors and at least one index. Further, evaluating the tensor graph can further include the following functions: selecting indexed tensors of the at least two tensors associated with a first index of the at least one index; contracting the tensor graph over the first index by summing the product of the indexed tensors as a resulting tensor; and adding the resulting tensor to the tensor graph.

Evaluating the tensor graph further can further include functions to order the at least two tensors from a minimum rank of a tensor to a maximum rank of a tensor. Ordering the at least two tensors can include ordering to provide the maximum rank of a tensor as a smallest maximum rank of a tensor. The quantum circuit of the quantum circuit input file can include at least one hundred input quantum gates.

Execution of the classical programming by the classical processor may further include configuring the classical computer to perform functions to identify a quality contraction tree, and to contract the tensor graph based upon the contraction tree. Identifying the quality contraction tree can include constructing a preliminary contraction tree, selecting a labeling of the leaves of the preliminary contraction tree, and optimizing the preliminary contraction tree based on the labeling of the leaves: The optimized preliminary contraction tree is the identified quality contraction tree. Optimizing the preliminary contraction tree cam include computing a minimal possible edge congestion for the preliminary contraction tree, computing a minimal vertex congestion for the preliminary contraction tree, and computing a minimum possible number of Floating Point Operations per Second (FLOPs) for the preliminary contraction tree. Contracting the tensor graph based on the contraction tree can include selecting an order of contraction which minimizes the sum total of lengths of stretched edges in the tensor graph.

The classical memory can further include an optimization problem file with a solution. Execution of the classical programming by the classical processor configures the classical computer to perform the following functions: simulating a benchmark processor; simulating a quantum processing unit conforming to the quantum circuit of the selected quantum circuit input file; simulating providing the quantum processing unit the optimization problem file; and simulating providing the benchmark processor the optimization problem file. The simulated quantum processing unit may locate the solution in a first period of time, wherein the simulated benchmark processor locates the solution in a second period of time, in which the first period of time is shorter than the second period of time.

In accordance with another aspect of the invention a computing system includes a classical processor and a classical memory coupled to the classical processor. The computing system includes a gate-graph conversion array in the classical memory, which itself includes at least one correspondence between a conversion quantum gate and a conversion graphical representation. The computing system further includes a quantum processing unit fabricator, configured to fabricate one or more quantum processing units conforming to a respective quantum circuit. The classical memory further includes classical programming in the classical memory, wherein execution of the classical programming by the classical processor configures the classical computer to perform the following functions: receiving a plurality of quantum circuit input files, each quantum circuit input file including a quantum circuit comprising at least one input quantum gate; converting each quantum circuit of the quantum circuit input files into a tensor graph utilizing the gate-graph conversion array; evaluating the tensor graph as a contraction tree; outputting a selected quantum circuit input file of the plurality of quantum circuit input files with a potential to demonstrate quantum advantage over one or more non-selected quantum circuit input files of the plurality of quantum circuit input files; and causing the quantum processing unit fabricator to fabricate a quantum processing unit conforming to the selected quantum circuit input file.

The computing system can further include a benchmark processor and an optimization problem file with a solution. The quantum processing unit is provided the optimization problem file, and the quantum processing unit locates the solution in a first period of time. The benchmark processor is provided the optimization problem file, and the benchmark processor locates the solution in a second period of time. The first period of time is shorter than the second period of time.

The tensor graph may include at least two tensors and at least one index. Evaluating the tensor graph may further comprise the following functions: selecting indexed tensors of the at least two tensors associated with a first index of the at least one index; contracting the tensor graph over the first index by summing the product of the indexed tensors as a resulting tensor; and adding the resulting tensor to the tensor graph.

In accordance with yet another aspect of the present invention a computer readable storage medium, having data stored therein representing software executable by a computer. The software includes the following instructions: receiving a plurality of quantum circuit input files, each quantum circuit input file including a quantum circuit comprising at least one input quantum gate; converting each quantum circuit into a tensor graph utilizing the gate-graph conversion array; evaluating the tensor graph as a contraction tree; and outputting a selected quantum circuit input file of the plurality of quantum circuit input files with a potential to demonstrate quantum advantage over one or more non-selected quantum circuit input files of the plurality of quantum circuit input files.

The software can further include the following additional instructions: selecting indexed tensors of the at least two tensors associated with a first index of the at least one index; contracting the tensor graph over the first index by summing the product of the indexed tensors as a resulting tensor; and adding the resulting tensor to the tensor graph.

### BRIEF DESCRIPTION OF THE DRAWINGS

FIG. 1 is a depiction of matrix multiplication including a first matrix M₁ and a second matrix M₂, as well as a selection of the operations required to calculate selected values in the multiplied matrix.

FIG. 2 is a depiction of a contraction tree representing an example tensor graph.

FIG. 3 is pseudocode depicting a CalcShared algorithm, which returns the shared indices of a given set of tensors.

FIG. 4 is pseudocode depicting the tree structure optimization algorithm, which solves the Matrix Chain Ordering Problem.

FIG. 5 depicts a classical computer or computing system which implements the code which solves the Matrix Chain Ordering problem in order to identify optimally efficient quantum circuits.

FIG. 6A is a graph depicting the vertex congestion performance of Tamaki-2017 as a scatterplot compared to vertex congestion performance of the tree structure optimization as a line.

FIG. 6B is a graph depicting the vertex congestion performance of FlowCutter as a scatterplot compared to vertex congestion performance of the tree structure optimization as a line.

FIG. 7A is a graph depicting the edge congestion performance of Cotengra as a scatterplot compared to edge congestion performance of the tree structure optimization as a line.

FIG. 7B is a graph depicting the minimizing operation count performance of FlowCutter as a scatterplot compared to minimizing operation count performance of the tree structure optimization as a line.

### DETAILED DESCRIPTION OF THE INVENTION

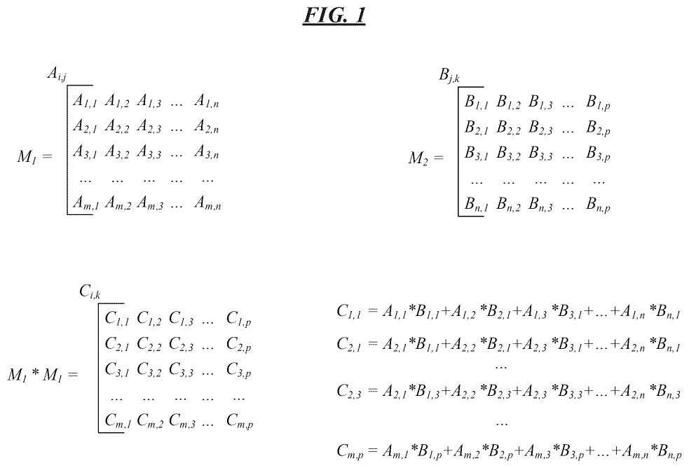

FIG. 1 is a depiction of matrix multiplication including a first matrix M₁ and a second matrix M₂, as well as a selection of the operations required to calculate selected values in the multiplied matrix.

An m by n matrix M is a 2-dimensional array of scalar numbers from some field [symbol] (e.g. [symbol] , [symbol] ). Matrix M has two indices, i and j, where size(i)=m and size(j)=n. The size of M is size(M)=size(i) size(j). As shown in FIG. 1, a matrix M₁ with indices {i,j} and a matrix M₂ with indices {j,k} can be combined to form a matrix M₁ * M₂ with indices {i,k} using an operation known as matrix multiplication. Note that the output has the indices of both its inputs (i and k) with the shared index (j) removed. The number of operations required to perform a matrix multiplication is size(i) * size(j) * size(k).

In an example are matrices M₁, M₂, . . . , Mₙ₋₁, Mₙ with indices {i₁, i₂}, {i₂,i₃}, . . . , {iₙ₋₁,iₙ}, {iₙ, iₙ₊₁}, respectively. The Matrix Chain Ordering Problem aims to find the optimal parenthesization of the matrix chain expression

$${M}_{1} * {M}_{2} * … * {M}_{n - 1} * {M}_{n}$$

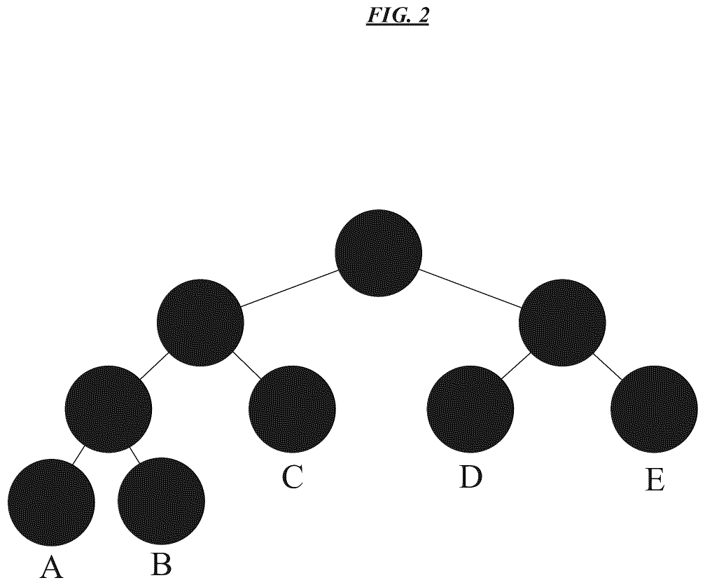

which minimizes the cost of computing this product. This setup assumes each matrix shares indices only with its neighbors. A given parenthesization can be expressed as a binary tree with leaves labeled with matrices. For example, the binary tree in FIG. 2 corresponds to the parenthesized matrix chain

((A*B)*C)*(D*E)

Tensors are defined analogously. A tensor X is an N-dimensional array of scalar numbers from some field [symbol] with indices I={i₁, . . . , i_{N}}. For a tensor X and an index i, X and i are incident to one another if i is an index of X. inc(X) is defined as the set of indices incident to X and define inc(i) as the set of tensors incident to i. The size of a tensor X is given by

$$size ( X ) = {\prod }_{i ∈ inc ( X )} size ( i )$$

Two tensors, a first tensor X₁ with indices I₁, and a second tensor X₂ with indices I₂ can similarly be combined using an operation known as tensor contraction. The output X₁ * X₂ will have indices I₁ΔI₂, where Δ denotes symmetric difference. The output having indices equal to the union of the input indices, with the intersection removed, is symmetric difference. I₁ΔI₂ are output indices, while I₁∩I₂ are known as the shared indices. The number of scalar operations (ops) required to perform a tensor contraction is given by

$$ops ( X , Y ) = size ( X * Y ) share ( X , Y )$$

$$where$$

$$share ( X , Y ) = {\prod }_{i ∈ S} size ( i ) , S = inc ( X ) ⋂ inc ( Y )$$

A set of tensors [symbol] ={X₁, . . . , Xₙ} with indices

$$𝒥 = {⋃}_{X ∈ 𝒯} inc ( X )$$

is known as a tensor network. Defining [symbol] ⁽⁰⁾= [symbol] , a tensor network contraction iteratively picks X^{(k)}, Y^{(k)}∈ [symbol] ^{(k)} to produce

$${𝒯}^{( k + 1 )} = ( {𝒯}^{( k )} ∖ \{ {X}^{( k )} , {Y}^{( k )} \} ) ⋃ \{ {X}^{( k )} * {Y}^{( k )} \}$$

Terminating when | [symbol] ^{(k)}|=1. A contraction order used for this tensor network contraction can again be represented as a binary tree. For example, the tree shown in FIG. 2 corresponds to the network contraction

$${T}^{( 0 )} = \{ A , B , C , D , E \}$$

$${T}^{( 1 )} = \{ A * B , C , D , E \}$$

$${T}^{( 2 )} = \{ ( A * B ) * C , D , E \}$$

$${T}^{( 3 )} = \{ ( A * B ) * C , D * E \}$$

$${T}^{( 4 )} = \{ ( ( A * B ) * C ) * D * E \}$$

Contraction of a tensor network is #P-Hard in the general case. However, many tensor networks arising in practice may be contracted efficiently given a good quality contraction order with respect to some cost function. The costs considered in these examples are the sum of the number of scalar operations, maximum number of scalar operations, and maximum tensor size, which are defined as follows:

$${\sum }_{k} ops ( {X}^{( k )} , {Y}^{( k )} )$$

$${max}_{k} ops ( {X}^{( k )} , {Y}^{( k )} ) , {max}_{k} size ( {X}^{( k )} * {Y}^{( k )} )$$

The problem of finding an optima contraction order is itself NP-Hard.

While minimizing the number of scalar operations required would seem to be more useful than minimizing the maximum number of operations for any contraction, the latter is useful in a parallel setting where many contractions can be performed simultaneously.

A particular type of quantum circuit is the Quantum Approximate Optimization Algorithm (QAOA) ansatz (or assumed forms), particularly those developed to target the graph theoretic MaxCut problem. QAOA is a variational quantum-classical algorithm inspired by the adiabatic evolution principle. It is essentially a quantum annealer with a finite number of steps p, implemented on a classical computing system. The quality of the final solution increases with p, as does the complexity of the circuit.

In quantum circuit simulation, it is possible to represent a quantum circuit as a high dimensional tensor over the complex numbers or, equivalently, as a tensor network. In this perspective, each quantum gate is associated with a tensor X with indices corresponding to the inputs and outputs of the gate. Two tensors in such a network will share an index only if it corresponds to a value that has been passed from one corresponding gate to the other. The examples disclosed herein assume the size of every index in the network is 2, though other sizes are contemplated.

With this construction, the costs of the maximum number of scalar operations and the costs of the maximum tensor size are related to contemporary systems which achieve similar estimations on the computational cost of tensor network contractions via quantities called vertex congestion, edge congestion, and treewidth.

In particular, vertex congestion and treewidth are equal to the log of the maximum number of operations needed for any contraction

$${max}_{k} {log}_{2} ops ( {X}^{( k )} , {Y}^{( k )} )$$

while edge congestion is equal to the log of the maximum size of any intermediate tensor

$${max}_{k} {log}_{2} size ( {X}^{( k )} , {Y}^{( k )} )$$

An undirected G=(V, E) with no loops and multi-edges, is a set V of vertices and a set

$$E ⊆ ( \begin{matrix}V \\ 2\end{matrix} )$$

of edges. The weights on the edges of the graph are denoted by the weighting function w: E→ [symbol] _{≥0}. For an edge uv∈E, w(uv) denotes its weight. The set of incident edges of a vertex v is the set of edges containing v, denoted inc(v)={e∈E|v∈e}. The degree of v is the number of edges incident to v, deg(v)=|inc(v)|.

A tensor network [symbol] with indices [symbol] where |inc(i)|=2 for all i∈ [symbol] . Then [symbol] admits a representation as a weighted, undirected graph G=(V, E). Let [symbol] be the function which assigns tensors to vertices and indices to edges, such that [symbol] (i)={ [symbol] (X), [symbol] (Y)} if and only if i∈inc(X)∩inc(Y). The weight function w is defined as w( [symbol] (i))=log₂ size(i).

A linear vertex ordering for a graph G=(V, E) is a bijective mapping σ:V→{1, . . . , |V|}. A linear ordering problem on a graph generally aims to find a linear ordering which minimizes a given cost function, such as the p-Sum objective, which is defined as

$${( {\sum }_{uv ∈ E} w ( uv ) {\vert σ ( u ) - σ ( v ) \vert}^{p} )}^{1 / p}$$

For the special case where p=I, this problem is known as the Minimum Linear Arrangement Problem.

The multilevel approach is a big class of algorithms actively used in many different areas of scientific computing, optimization, and machine learning. These examples briefly describe a version of multilevel algorithms for graph optimization problems. When the graph is large and a fast solution of an optimization problem is required for a specific application, it is often useful to compress the problem by (possibly nonlinearly) aggregating variables into, so called, coarse variables. This is done in a such way that a solution for each coarse variable can be effectively interpolated back to those variables that participated in the aggregation. The entire process of problem coarsening is performed gradually forming a multilevel hierarchy of coarse problems. Each next coarser problem approximates the previous finer problem from which it has been created. Thus, the number of variables at each level of this hierarchy is decreasing which allows to solve them faster than the original problem. When sufficiently small coarsest level is created, the best possible (often exact) solution is computed. The last stage of framework (called uncoarsening) is to gradually solve the problems at each level of coarseness by (1) interpolating the initial solution for the current fine level from the coarser level, and (2) refining the interpolated solution.

If both coarsening and uncoarsening are computed locally (i.e., their complexity is linear in the number of variables) then the entire multilevel framework becomes of linear or nearly-linear complexity, assuming that the number of variables at each level is decreasing within a factor of 1.5-2.5. This approach is different than such one-shot compression approaches as truncated singular value decomposition (SVD). Such problems on graphs as partitioning, various linear orderings, and community detection have benefited from the multilevel approaches.

A parenthesization of a matrix chain expression or a contraction order for a tensor network both admit representations as binary trees with labelled leaves.

It is useful to introduce a more direct tensor variant of the Matrix Chain Ordering Problem, known as the Tensor Chain Ordering Problem. Given tensors X₁, . . . , Xₙ, find an optimal parenthesization of the tensor chain expression

X₁* . . . *Xₙ

Which minimizes one of the sum of the number of scalar operations, the maximum number of scalar operations, or the maximum tensor size. Notably, indices are not restricted to immediate neighbors in the chain. Given a binary tree T representing a contraction order O for a tensor network [symbol] , consider the linear ordering σ of tensors corresponding to a left to right traversal of the labelled leaves of T. Then T could be considered a possible solution to the Tensor Chain Ordering Problem for the chain

$${σ}^{- 1} ( 1 ) * … * {σ}^{- 1} ( n )$$

Then finding a contraction order for a tensor network can actually be reframed as finding a linear ordering of the tensors in the network, then solving the Tensor Chain Order Problem.

$${min}_{O} cost ( 𝒯 O ) = {min}_{σ} {min}_{𝒯} cost ( 𝒯 , σ , 𝒯 )$$

Solving the Tensor Chain Order Problem for a fixed linear order σ tree structure optimization. Notably, an optimal contraction order of the Tensor Chain Order Problem can be found deterministically in polynomial time as demonstrated in the following section. This decouples the actual computationally Hard task of finding an optimal order of the chain, from the more tractable task of actually constructing the tree.

The solution to the Tensor Chain Order Problem can be solved with dynamic programming. Given an example tensor chain expression X₁* . . . *Xₙ. Let X_{i,j}=Xᵢ*Xᵢ₊₁* . . . *Xⱼ for i<j.

The following recursion computes the minimal edge congestion of any parenthesization of the tensor chain

$$c ( i , i ) = size ( {X}_{i} )$$

$$c ( i , j ) = {min}_{i \leq k < j} max \{ \begin{matrix}{log}_{2} size ( {X}_{i , k} * {X}_{k + 1 , j} ) \\ c ( i , k ) \\ c ( k + 1 , j )\end{matrix}$$

as well as the minimal vertex congestion of the parenthesization of the tensor chain

$$c ( i , i ) = size ( {X}_{i} )$$

$$c ( i , j ) = {min}_{i \leq k < j} max \{ \begin{matrix}log & ops ( {X}_{i , k} * {X}_{k + 1 , j} ) \\ & c ( i , k ) \\ & c ( k + 1 , j )\end{matrix}$$

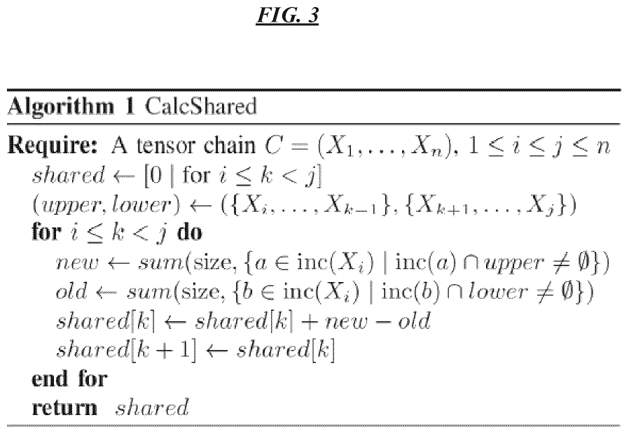

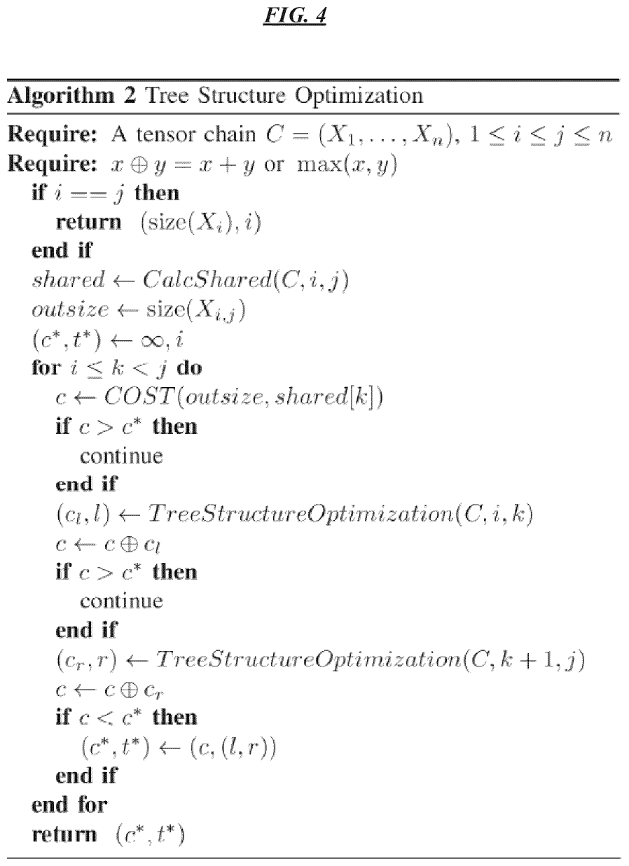

To avoid attempting to calculate share (X_{i,k}, X_{k+1,j}) at each iteration, the dynamic programming Tree Structure Optimization algorithm in FIG. 4 (which selectively calls the CalcShared algorithm of FIG. 3) is utilized to compute the minimal possible size of the largest tensor for any contraction tree given an order. Pruning is utilized in order to reduce the number of needed computations, as there is no need to evaluate the second subsequence in a split if the first has already exceeded the current best result. Performance can be further improved by making use of memoization to cache previous calls. Memoization ensure that a method does not run for identical inputs more than once by keeping a record of the results for given inputs. Memoization can be implemented within a hash map or other known structures. Additional gains may be achieved by parallelizing the evaluation of disjoint subproblem calls. Utilizing these techniques, the time complexity of Tree Structure Optimization algorithm in FIG. 4 is 0(|E||V|²+d|V|³).

An alternative example for the classical total number of operations can be achieved by looking at the incremental sum of the left and right trees rather than the max.

$$c ( i , i ) = size ( {X}_{i} )$$

$$c ( i , j ) {min}_{i \leq k < j} ops ( {X}_{i , k} , {X}_{k + 1 , j} ) + c ( i , k ) + c ( k + 1 , j )$$

Before constructing an optimal contraction tree given a particular order, a particular order must be chosen. A heuristic approach solves this problem. In particular, an approach selecting an order which minimizes the sum total of lengths of stretched edges in the graph. This approach is known as the Minimal Linear Arrangement (MLA) of the vertices in the graph, and is defined as

$${\sum }_{uv ∈ E} w ( uv ) \vert σ ( u ) - σ ( v ) \vert$$

This approach is motivated by the property of matrix chains sharing indices only with their immediate neighbors. An order which minimizes MLA discourages long stretched edges on the chain. Such an ordering has been empirically observed to be effective in reducing the congestion of the resulting contraction tree.

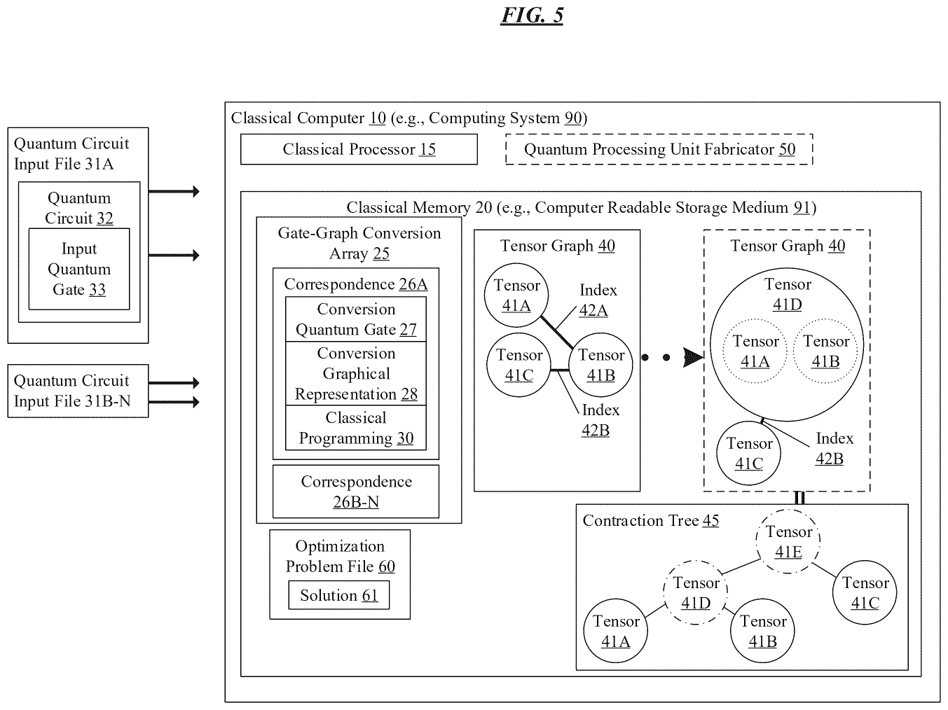

FIG. 5 is an illustration of a computing system implementing the processes described above, and in particular in FIG. 3 and FIG. 4. A classical computer 10 including a classical processor 15 and a classical memory 20 coupled to the classical processor 15. As used herein, the term “classical” when used to modify terms such as “computer,” “processor,” “memory,” and the like, refers to a computer system and its components that use traditional techniques long known in the art, as compared to “quantum” computing techniques as referred to elsewhere herein. The classical computer 10 includes a gate-graph conversion array 25 in the classical memory 20, which itself includes at least one correspondence 26A between a conversion quantum gate 27 and a conversion graphical representation 28. The conversion quantum gate 27 is a physical quantum gate, or a potential or planned quantum gate within a potential quantum circuit design schematic. The conversion graphical representation 28 is a virtualized abstract representation of a quantum gate, represented as vertices and indices with relationships to other quantum gates, collectively forming the potential or abstract quantum circuit.

The classical memory 20 further includes classical programming 30 in the classical memory 20, wherein execution of the classical programming 30 by the classical processor 15 configures the classical computer 10 to perform the following functions. The classical computer 10 receives a plurality of quantum circuit input files 31A-N, where each quantum circuit input file 31A-N includes a quantum circuit 32 comprising at least one input quantum gate 33. The classical computer 10 converts each quantum circuit 32 into a tensor graph 40 by utilizing the gate-graph conversion array 25. The classical computer does so by comparing the input quantum gate 33 to one or more conversion quantum gates 27 until a match is found: once matched, the conversion graphical representation 28 corresponding via the correspondence 26A to the matching conversion quantum gate 27 is used to represent the quantum circuit 32 in the tensor graph 40.

The classical computer 10 evaluates the tensor graph 40 as a contraction tree 45. The evaluation follows the processes described above and depicted in FIGS. 1-4, with tensor 41D as a contraction of tensor 41A with tensor 41B, and tensor 41E as a contraction of tensor 41C with tensor 41D. The classical computer 10 outputs a selected quantum circuit input file 31A of the plurality of quantum circuit input files 31A-N, the selected quantum circuit input file 31A with a potential to demonstrate quantum advantage over one or more non-selected quantum circuit input files 31B-N of the plurality of quantum circuit input files 31A-N. Quantum advantage in this context indicates an ability to solve a particular quantum problem over and above the abilities of a non-selected quantum circuits, with the quantum problem itself being unsolvable by a classical computer in a feasible amount of time.

The classical computer 10 can include a quantum processing unit fabricator 50, configured to fabricate one or more quantum processing units conforming to the selected quantum circuit input file 31A. Execution of the classical programming by the classical processor 15 configures the classical computer 10 to perform the function of fabricating, via the quantum processing unit fabricator 50, a quantum processing unit conforming to the selected quantum circuit input file 31A. Once a quantum circuit input file 31A is selected, it can be advantageous to actually manufacture the quantum circuit-in other cases, the selected quantum circuit 31A can advance research into other quantum circuits based on the simulation of that selected quantum circuit 31A by a classical computer 10, or by proving that a, the, or any quantum circuit 31A is capable of achieving quantum supremacy over a particular quantum problem.

The tensor graph 40 can include at least two tensors 41A-C and at least one index 42A-B. The tensors 41A-C represent the quantum gates 33 of the quantum circuits 32 of the quantum circuit input file 31A, and the index 42A-B represents the inputs and outputs connecting two particular quantum gates 33. Evaluating the tensor graph 40 can further include the following functions: the classical computer 10 selects indexed tensors 41A-B of the at least two tensors 41A-C associated with a first index 42A of the at least one index 42A-B. The classical computer 10 contracts the tensor graph 40 over the first index 42A by summing the product of the indexed tensors 41A-B as a resulting tensor 41D; and adding the resulting tensor 41D to the tensor graph 40. Tensors 41A-B are shown within tensor 41D, as this coarsening or contracting tensors 41A-B into tensor 41D is done in a such way that a solution for each coarse variable can be effectively interpolated back to those variables that participated in the aggregation.

Evaluating the tensor graph 40 can further include functions to order the at least two tensors 41A-C from a minimum rank of a tensor to a maximum rank of a tensor. This ordering of the tensors will result in a solution to the Tensor Chain Ordering Problem for the set of tensors 41A-C. Ordering the at least two tensors 41A-C can include ordering to provide the maximum rank of a tensor as a smallest maximum rank of a tensor. The quantum circuit 32 of the quantum circuit input file 31A can include at least one hundred input quantum gates 33, however any number of input quantum gates 33 are contemplated.

Execution of the classical programming 30 by the classical processor 15 may further include configuring the classical computer 30 to perform functions to identify a quality contraction tree 45, and to contract the tensor graph 40 based upon the contraction tree 45. Identifying the quality contraction tree 45 can include constructing a preliminary contraction tree, selecting a labeling of the leaves 41A-C of the preliminary contraction tree, and optimizing the preliminary contraction tree based on the labeling of the leaves 41A-C: The optimized preliminary contraction tree is the identified quality contraction tree 45. Optimizing the preliminary contraction tree can include computing a minimal possible edge congestion for the preliminary contraction tree, computing a minimal vertex congestion for the preliminary contraction tree, and computing a minimum possible number of Floating Point Operations per Second (FLOPs) for the preliminary contraction tree. Contracting the tensor graph 40 based on the contraction tree 45 can include selecting an order of contraction which minimizes the sum total of lengths of stretched edges in the tensor graph 40.

The classical memory 20 can further include an optimization problem file 60 with a solution 61. Execution of the classical programming 30 by the classical processor 15 configures the classical computer 10 to perform the following functions. The classical computer 10 simulates a benchmark processor. The classical computer 10 simulates a quantum processing unit conforming to the quantum circuit 32 of the selected quantum circuit input file 31A. The classical computer 10 simulates providing the quantum processing unit the optimization problem file 60. The classical computer 10 simulates providing the benchmark processor the optimization problem file 60. The simulated quantum processing unit may locate the solution in a first period of time, wherein the simulated benchmark processor locates the solution in a second period of time, in which the first period of time is shorter than the second period of time. Meaning, the simulated quantum processing unit, based upon the selected quantum circuit 32, solves the optimization problem 60 more efficiently than a simulated benchmark or standard processor, which may be a simulated quantum processor or a simulated classical processor.

FIG. 5. equivalently depicts a computing system 90 including a classical processor 15 and a classical memory 20 coupled to the classical processor 15. The computing system 90 includes a gate-graph conversion array 25 in the classical memory 30, which itself includes at least one correspondence 26A between a conversion quantum gate 27 and a conversion graphical representation 28. The computing system 90 further includes a quantum processing unit fabricator 50, configured to fabricate one or more quantum processing units conforming to a respective quantum circuit 32. The classical memory 20 further includes classical programming 30 in the classical memory, wherein execution of the classical programming 30 by the classical processor 15 configures the computing system 90 to perform the following functions. The computing system 90 receives a plurality of quantum circuit input files 31A-N, each quantum circuit input file 31A-N including a quantum circuit 32 comprising at least one input quantum gate 33. The computing system 90 converts each quantum circuit 32 of the quantum circuit input files 31A-N into a tensor graph 40 utilizing the gate-graph conversion array 25. The computing system 90 evaluates the tensor graph 40 as a contraction tree 45. The computing system 90 outputs a selected quantum circuit input file 31A of the plurality of quantum circuit input files 31A-N with a potential to demonstrate quantum advantage over one or more non-selected quantum circuit input files 31B-N of the plurality of quantum circuit input files 31A-N. The computing system 90 causes the quantum processing unit fabricator 50 to fabricate a quantum processing unit conforming to the selected quantum circuit input file 31A.

The computing system can further include a benchmark processor and an optimization problem file 60 with a solution 61. The quantum processing unit is provided the optimization problem file 60, and the quantum processing unit locates the solution 61 in a first period of time. The benchmark processor is provided the optimization problem file, and the benchmark processor locates the solution in a second period of time. The first period of time is shorter than the second period of time. Here, the quantum processing unit, and the benchmark processor are physical processors.

The tensor graph 40 may include at least two tensors 41A-C and at least one index 42A-B. Evaluating the tensor graph 40 may further comprise the following functions. The computing system 90 selects indexed tensors 41A-B of the at least two tensors 41A-C associated with a first index 42A of the at least one index 42A-B. The computing system 90 contracts the tensor graph 40 over the first index 42A by summing the product of the indexed tensors 41A-B as a resulting tensor 41D. The computing system 90 adds the resulting tensor 41D to the tensor graph 40.

FIG. 5 further depicts a computer readable storage medium 91, having data stored therein representing software executable by a computer. The software includes the following instructions: receiving a plurality of quantum circuit input files 31A-N, each quantum circuit input file 31A-N including a quantum circuit 32 comprising at least one input quantum gate 33. Converting each quantum circuit 32 into a tensor graph 40 utilizing a gate-graph conversion array 25. Evaluating the tensor graph 40 as a contraction tree 45. Outputting a selected quantum circuit input file 31A of the plurality of quantum circuit input files 31A-N with a potential to demonstrate quantum advantage over one or more non-selected quantum circuit input files 31B-N of the plurality of quantum circuit input files 31A-N.

The software can further include the following additional instructions. Selecting indexed tensors 41A-B of the at least two tensors 41A-C associated with a first index 42A of the at least one index 42A-B. Contracting the tensor graph 40 over the first index 42A by summing the product of the indexed tensors 41A-B as a resulting tensor 41D. Adding the resulting tensor 41D to the tensor graph 40.

While discussed herein primarily in the context of minimizing Minimum Linear Arrangement by making local changes to the order at each level of the algorithm, which has been demonstrated to be an effective heuristic for the tested circuits, refinement strategies that directly target the width of the order may also be implemented. Specifically, local changes may be implemented to reduce the width of the overall order.

In embodiments, the algorithms as discussed herein for tree structure optimization may be parallelized, particularly for use in a high-performance computing environment already designed for circuit simulation.

While the disclosure herein primarily considers tensor networks representable as normal undirected graphs, with each index in the circuit associated with a corresponding edge in the graph, for some quantum circuits, one cost-saving technique may include reconsidering certain collections of indices as hyperindices: in essence a single index connecting multiple gates, thus introducing a hypergraph structure to the tensor network representation, permitting a higher order generalization of undirected graphs. Hypergraph partitioning software may be useful for such considerations. In particular, how the hypergraph structure may inform the coarsening portion of the ordering problem may be considered by evaluating various kernels and similarity measures on high order structures using a tree structure optimization algorithm for higher order structures.

Classical processor 15 serves to perform various operations, for example, in accordance with instructions or programming executable by the classical processor 15. Although the classical processor 15 may be configured by use of hardwired logic, typical classical processors 15 may be general processing circuits configured by execution of programming. The classical processor 15 includes elements structured and arranged to perform one or more processing functions, typically various data processing functions. Although discrete logic components may be used, the examples utilize components forming a programmable CPU. The classical processor 15, for example, may include one or more integrated circuit (IC) chips incorporating the electronic elements to perform the functions of the CPU. The classical processor 15, for example, may be based on any known or available microprocessor architecture, such as a Reduced Instruction Set Computing (RISC) using an ARM architecture, commonly used in mobile devices and other portable electronic devices. Of course, other processor circuitry may be used to form the classical processor 15.

The instructions, programming, or application(s) may be software or firmware used to implement any other device functions associated with the classical computer 10, computing system 90, and the quantum processing unit fabricator 50. Program aspects of the technology may be thought of as “products” or “articles of manufacture” typically in the form of executable code or process instructions and/or associated data that is stored on or embodied in a type of machine or processor readable medium (e.g., transitory or non-transitory), such as a memory of a computer used to download or otherwise install such programming into the classical computer 10, computing system 90, and the quantum processing unit fabricator 50, or a transportable storage device or a communications medium for carrying program for installation in the classical computer 10, computing system 90, and the quantum processing unit fabricator 50. Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

The PCs, printers and scanners described throughout the specification include but are not limited to classical processor 15 (e.g. CPU) for performing the tensor contraction algorithms, classical memory 20 for storing data and programming instructions for supporting the operation of classical processor 15, and any transceivers (e.g. wired, wireless, Bluetooth, WiFi, etc.) for communication between devices.

The instructions, programming, or application(s) may be software or firmware used to implement the device functions associated with the device such as the scanners, printers and PCs described throughout this description. Program aspects of the technology may be thought of as “products” or “articles of manufacture” typically in the form of executable code or process instructions and/or associated data that is stored on or embodied in a type of machine or processor readable medium (e.g., transitory or non-transitory), such as a memory of a computer used to download or otherwise install such programming into the source/destination PC and/or source/destination printer.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

### EXAMPLES

There are several algorithms which may be used as a comparative reference to the above processes and systems: these algorithms collectively produce some of the intermediate mathematical output used in the above processes and systems, but as experimental results will show, do so in a less-efficient manner. Therefore, the above processes and systems improve the functioning of a computer in selecting and designing quantum circuits, as well as improve the technology and technical field of quantum circuitry.

FlowCutter is used collectively to refer to an algorithm for computing small, balanced s-t cuts using Pareto optimization, as well as an algorithm utilizing the former to construct a tree decomposition of the input graph via recursive bisection, that is also a form of a multilevel algorithm.

FlowCutter was entered into heuristic track of the PACE 2017 Parameterized Algorithms and Computational Experi-ments Challenge on minimizing treewidth, where it placed second as the only solver to find a solution for all test instances in the allotted 30 minutes. Moreover, FlowCutter is known to be useful in finding high quality tensor network contraction.

The Tamaki-2017 solver is a tree decomposition solver with components submitted to the exact and heuristic tracks for PACE 2017. On the heuristic track, this solver ranked first place, tending to achieve better results on smaller instances than the competitive approaches, while sometimes failing to find an answer in the allotted time for larger instances.

The Tamaki-2017 algorithm is based on positive-instance driven dynamic programming, and, similar to FlowCutter, operates recursively on minimal separators of the instance graph.

Cotengra is a library for the efficient contraction of tensor networks. In their seminal paper on the subject, the authors introduce a method for directly constructing con-traction trees based on recursive bisection. By utilizing existing hypergraph partitioning solvers such as KaHyPar, Cotengra is able to construct contraction trees utilizing the hypergraph structure of some inputs that arise in Quantum Circuit Simulation. Cotengra also utilizes the Bayesian optimization strategy, varying the hyperparameters of the partitioning solver at various levels in order to account for a changing graph structure as the algorithm progresses.

cuTENSOR is a tensor network Compute Unified Device Architecture (CUDA) library in development by NVidia, which aims to bring high performance tensor primatives to the GPU. Because not much information about their specific method for determining contraction orders is publicly available at the time of writing, we will not be comparing to cuTENSOR at this time.

The Tree Structure Optimization has been evaluated against the above existing state of the art algorithms Tamaki-2017, FlowCutter, and Cotengra on a collection of randomly generated QAOA circuits. To generate test results for tree structure optimization, an order for the graph with a good minimum linear arrangement objective is found, then a tree structure optimization is run with the relevant cost. This process is done repeatedly while varying the random seed to create an anytime style algorithm. The process is run for 5 seconds. In most cases a significant improvement in the quality of results is observed given a comparable running time (a running time that is usually negligible in comparison to the quantum simulation time itself).

For a fixed depth p and degree I, a p layer QAOA ansatz circuit is constructed via simulation, targeting the Max Cut problem on a random 32 vertex d-regular graph using the QTensor library. For each combination of d=3, 4, 5 and QAOA depth p=2, 3, 4, 5, ten random circuits are generated to form the test set. The source code and generated circuits are available at https://github.com/cameton/TreeStructureOpt. In doing so, a variety of circuits are sampled with a varying level of connectedness and depth, which is used as a proxy for the complexity of the circuit; such circuits are commonly used in evaluations of contraction order solvers for quantum circuits.

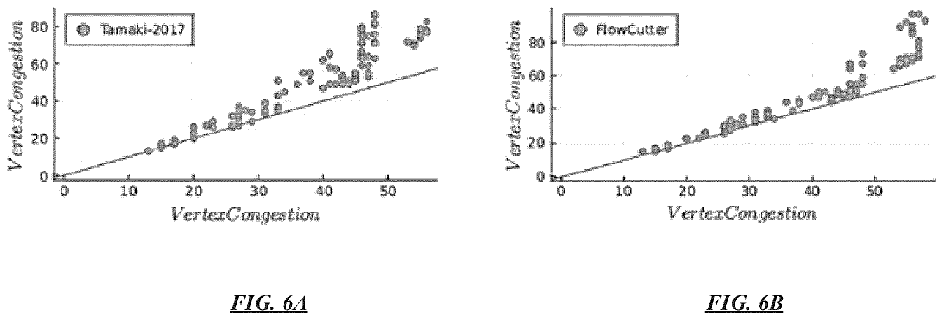

The vertex congestion of the solution found by our tree structure optimizer for the test set is compared against the vertex congestion of the solution found by Tamaki-2017 and FlowCutter by finding the tree decomposition of the line graph. As Cotengra has functionality to minimize edge congestion and number of flops, it is evaluated separately. For these experiments, each of these optimizers is run for 5 seconds. Results for this test are given in FIGS. 6A and 6B.

FIGS. 6A and 6B depict the vertex congestion achieved by Tamaki-2017 (FIG. 6A) and FlowCutter (FIG. 6B) plotted against the vertex congestion found by the tree structure optimization process on a minimum linear arrangement order. The plotted line represents the threshold at which both solvers achieved the same objective value. Points above this threshold indicate that tree structure optimization process found a superior value.

The tree structure optimization-based process performed strictly better than FlowCutter on 96.4% of points and better than Tamaki on 90.0% of points, while achieving an equal cost on every remaining instance. Additionally, the margin of improvement increases significantly as the vertex congestion of the circuit increases.

As vertex and edge congestion represent the log of the maximum size and maximum number of operations, even small improvements in congestion lead to significant gains. As such, having such a large improvement on so many points represents advantage of the tree structure optimization-based process over competitive solvers run for the same amount of time.

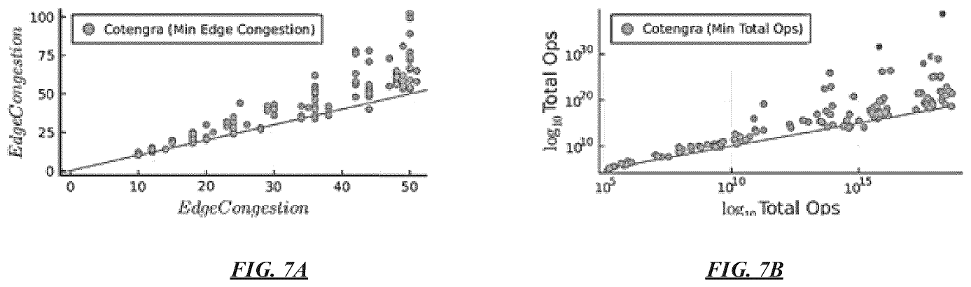

The edge congestion and estimated number of operations of the solution found by the tree structure optimizer process on the test set is compared against the edge congestion and estimated number of operations of the solution found by Cotengra. Cotengra is run for 5 seconds with default settings and the KaHyPar partitioner backend. Two tests are run: a first with Cotengra minimizing edge congestion, and a second where Cotengra set to minimize the total number of scalar operations. Results are given in FIGS. 7A and 7B.

FIGS. 7A and 7B depict the edge congestion of Cotengra minimizing edge congestion against tree structure optimization (FIG. 7A) and Cotengra minimizing operation count against tree structure optimization on a log-log scale (FIG. 7B). The plotted line represents the threshold at which both solvers achieved the same objective value. Points above this threshold indicate that tree structure optimization process found a superior value.

From FIGS. 7A and 7B, we see that tree structure optimization is highly competitive with Cotengra, in every case finding a solution which is close to or better than Cotengra in terms of both estimated number of FLOPs and edge congestion.

The tree structure optimization process bests Cotengra on a full 95% of points when minimizing total number of operations, and on 84.1% of points when minimizing edge congestion. These results demonstrate the superiority of the tree structure optimization process for comparatively short run times.

It should be understood that all of the figures as shown herein depict only certain elements of an exemplary system, and other systems and methods may also be used. Furthermore, even the exemplary systems may comprise additional components not expressly depicted or explained, as will be understood by those of skill in the art. Accordingly, some embodiments may include additional elements not depicted in the figures or discussed herein and/or may omit elements depicted and/or discussed that are not essential for that embodiment. In still other embodiments, elements with similar function may substitute for elements depicted and discussed herein.

Any of the steps or functionality of the system and method for converting graphic files for printing can be embodied in programming or one more applications as described previously. According to some embodiments, “function,” “functions,” “application,” “applications,” “instruction,” “instructions,” or “programming” are program(s) that execute functions defined in the programs. Various programming languages may be employed to create one or more of the applications, structured in a variety of manners, such as object-oriented programming languages (e.g., Objective-C, Java, or C++), procedural programming languages (e.g., C or assembly language), or firmware. In a specific example, a third party application (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating systems. In this example, the third party application can invoke API calls provided by the operating system to facilitate functionality described herein.

Hence, a machine-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that has, comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like, whether or not qualified by a term of degree (e.g. approximate, substantially or about), may vary by as much as ±10% from the recited amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected may lie in less than all features of any single disclosed example. Hence, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A classical computer, comprising:
a classical processor;
a classical memory, coupled to the classical processor;
a gate-graph conversion array stored in the classical memory, the conversion array including at least one correspondence between a conversion quantum gate and a conversion graphical representation; and
classical programming in the classical memory constituting machine readable instructions that when executed by the classical processor causes the classical processor to configure the classical computer to perform functions, including:
receiving a plurality of quantum circuit input files, each quantum circuit input file including a quantum circuit comprising at least one input quantum gate;
converting each quantum circuit into a tensor graph utilizing the gate- graph conversion array;
evaluating the tensor graph as a contraction tree; and
outputting a selected quantum circuit input file of the plurality of quantum circuit input files with a potential to demonstrate quantum advantage over one or more non-selected quantum circuit input files of the plurality of quantum circuit input files.

2. The classical computer of claim 1, further comprising:
a quantum processing unit fabricator connected to the computer processor, the quantum processing unit fabricator configured to fabricate one or more quantum processing units conforming to the selected quantum circuit input file;
wherein execution of the classical programming by the classical processor causes the quantum processing unit fabricator to fabricate a quantum processing unit conforming to the selected quantum circuit input file.

3. The classical computer of claim 1, wherein the tensor graph includes at least two tensors and at least one index.

4. The classical computer of claim 3, wherein evaluating the tensor graph further comprises functions to:
select indexed tensors of the at least two tensors associated with a first index of the at least one index;
contract the tensor graph over the first index by summing the product of the indexed tensors as a resulting tensor; and
add the resulting tensor to the tensor graph.

5. The classical computer of claim 4, wherein evaluating the tensor graph further comprises functions to order the at least two tensors from a minimum rank of a tensor to a maximum rank of a tensor.

6. The classical computer of claim 5, wherein ordering the at least two tensors includes ordering to provide the maximum rank of a tensor as a smallest maximum rank of a tensor.

7. The classical computer of claim 3, wherein evaluating the tensor graph further comprises functions to:
identify a quality contraction tree; and
contract the tensor graph based upon the contraction tree.

8. The classical computer of claim 7, wherein:
identifying the quality contraction tree includes:
constructing a preliminary contraction tree;
selecting a labeling of the leaves of the preliminary contraction tree; and
optimizing the preliminary contraction tree based on the labeling of the leaves; and
the optimized preliminary contraction tree is the identified quality contraction tree.

9. The classical computer of claim 8, wherein optimizing the preliminary contraction tree includes:
computing a minimal possible edge congestion for the preliminary contraction tree;
computing a minimal vertex congestion for the preliminary contraction tree;
computing a minimum possible number of Floating Point Operations per Second (FLOPs) for the preliminary contraction tree.

10. The classical computer of claim 7, wherein contracting the tensor graph based on the contraction tree includes:
selecting an order of contraction which minimizes the sum total of lengths of stretched edges in the tensor graph.

11. The classical computer of claim 1, wherein:
the classical memory further includes an optimization problem file with a solution; and
execution of the classical programming by the classical processor configures the classical computer to perform functions, including functions to:
simulate a benchmark processor;
simulate a quantum processing unit conforming to the quantum circuit of the selected quantum circuit input file;
simulate providing the quantum processing unit the optimization problem file; and
simulate providing the benchmark processor the optimization problem file; and
the simulated quantum processing unit locates the solution in a first period of time;
the simulated benchmark processor locates the solution in a second period of time; and
the first period of time is shorter than the second period of time.

12. A computing system, comprising:
a classical processor;
a classical memory, coupled to the classical processor;
a gate-graph conversion array in the classical memory, including at least one correspondence between a conversion quantum gate and a conversion graphical representation;
a quantum processing unit fabricator, configured to fabricate one or more quantum processing units conforming to a respective quantum circuit; and
classical programming in the classical memory, wherein execution of the classical programming by the classical processor configures the computing system to perform functions, including functions to:
receive a plurality of quantum circuit input files, each quantum circuit input file including a quantum circuit comprising at least one input quantum gate;
convert each quantum circuit of the quantum circuit input files into a tensor graph utilizing the gate-graph conversion array;
evaluate the tensor graph as a contraction tree;
output a selected quantum circuit input file of the plurality of quantum circuit input files with a potential to demonstrate quantum advantage over one or more non-selected quantum circuit input files of the plurality of quantum circuit input files; and
cause the quantum processing unit fabricator to fabricate a quantum processing unit conforming to the selected quantum circuit input file.

13. The computing system of claim 12, further comprising:
a benchmark processor; and
an optimization problem file with a solution;
wherein:
the quantum processing unit is provided the optimization problem file;
the quantum processing unit locates the solution in a first period of time;
the benchmark processor is provided the optimization problem file;
the benchmark processor locates the solution in a second period of time; and
the first period of time is shorter than the second period of time.

14. The computing system of claim 12, wherein the tensor graph includes at least two tensors and at least one index.

15. The computing system of claim 14, wherein evaluating the tensor graph further comprises functions to:
select indexed tensors of the at least two tensors associated with a first index of the at least one index;
contract the tensor graph over the first index by summing the product of the indexed tensors as a resulting tensor; and
add the resulting tensor to the tensor graph.

16. The computing system of claim 12, wherein the quantum circuit of the quantum circuit input file comprises at least one hundred input quantum gates.

17. A computer readable storage medium having data stored therein representing software executable by a computer, the software including instructions to:
receive a plurality of quantum circuit input files, each quantum circuit input file including a quantum circuit comprising at least one input quantum gate;
convert each quantum circuit into a tensor graph utilizing the gate-graph conversion array;
evaluate the tensor graph as a contraction tree; and
output a selected quantum circuit input file of the plurality of quantum circuit input files with a potential to demonstrate quantum advantage over one or more non-selected quantum circuit input files of the plurality of quantum circuit input files.

18. The computer readable storage medium of claim 17, wherein the software further includes instructions to:
select indexed tensors of the at least two tensors associated with a first index of the at least one index;
contract the tensor graph over the first index by summing the product of the indexed tensors as a resulting tensor; and
add the resulting tensor to the tensor graph.
